(19) United States
(12) Patent Application Publication
(10) Pub. No.: US 2008/0284113 A1
(43) Pub. Date: Nov. 20, 2008

(54) Gasket Having Formed Load Bearing Compression Limiting Features

(75) Inventor: Thomas A. Boardman, Tilton, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/750,646

(22) Filed: May 18, 2007

(51) Int. Cl. F02F 11/00

(52) U.S. Cl. 277/595

(57) ABSTRACT

A gasket is provided with a metallic substrate formed from a flat sheet of metal and is deformed to provide a raised beam portion that creates a load bearing compression limiting feature to control stresses on the over molded gasket material.

### FIELD

The present disclosure relates to gaskets and more particularly, to a gasket having a metal substrate with formed load bearing compression limiting features.

### BACKGROUND AND SUMMARY

The statements in this section merely provide background information related to the present disclosure and may not constitute prior art.

Current gaskets for stamped pan or cover applications, known as an over-molded gasket, consist of a thin stamped metallic carrier with inserted sintered compression limiters. The inserted sintered compression limiters add extra cost to the metallic carrier to create the necessary load bearing compression limiting feature. The present disclosure provides a compression limiting feature, formed in the metal gasket substrate by stamping, to eliminate the necessity of an additional sintered component and an additional assembly step.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a plan view of a metallic gasket substrate according to the principles of the present disclosure;

FIG. 2 is a cross-sectional view of a gasket illustrating a raised bead portion of the metallic gasket substrate according to the present disclosure;

FIG. 3 is a cross-sectional view of a gasket illustrating a portion of the gasket intermediate to the raised bead portion of the metallic gasket substrate according to the present disclosure;

FIG. 4 is a perspective view of a gasket substrate according to the principles of the present disclosure with a continuous raised bead portion; and

FIG. 5 is a plan view of a metallic gasket substrate according to the principles of the present disclosure;

FIG. 6 is a cross-sectional view taken along line 6-6 of FIG. 5;

FIG. 7 is a cross-sectional view taken along line 7-7 of FIG. 5; and

FIG. 8 is an alternative cross-sectional view taken along line 7-7 of FIG. 5.

### DETAILED DESCRIPTION

The following description is merely exemplary in nature and is not intended to limit the present disclosure, application, or uses. It should be understood that throughout the drawings, corresponding reference numerals indicate like or corresponding parts and features.

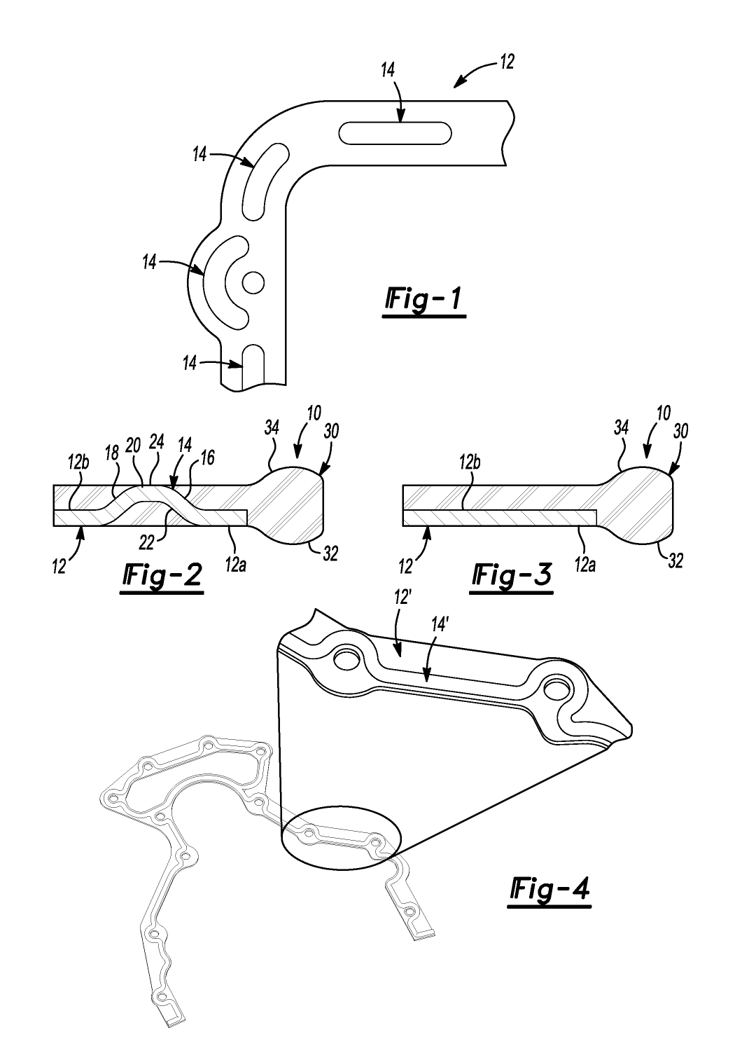

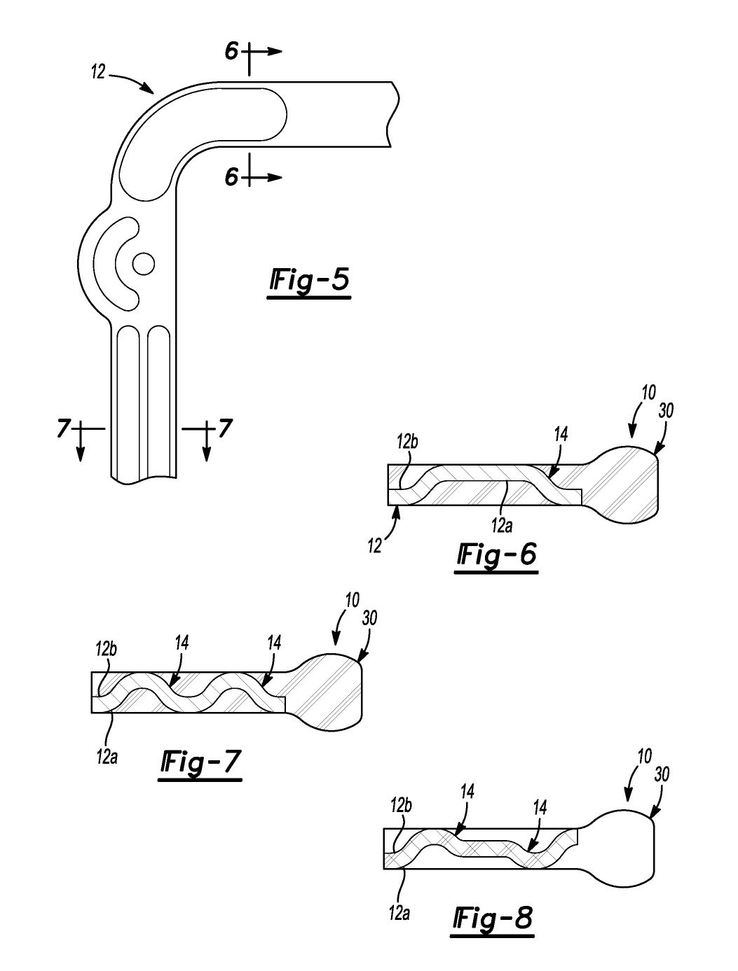

With reference to FIGS. 1-3a, gasket 10 according to the principles of the present disclosure will now be described. The gasket 10 includes a metallic gasket substrate 12 formed of a sheet metal. The substrate 12 can be stamped from a solid sheet and simultaneously formed with a raised bead portion 14 that serves as a load bearing compression limiting feature. The raised bead portions 14, 14′ include a pair of sidewall segments 16, 18 and a top wall segment 20 extending between the sidewall segments 16, 18. Accordingly, the raised bead portions 14 define a concave surface 22 on a first side 12a of the substrate 12 and define a convex surface 24 on a second side 12b of the substrate 12. The raised bead portion 14 of the metallic substrate 12 can be formed as a series of discreet raised bead portions 14 as illustrated in FIG. 1, or alternatively can be formed as a continuous raised bead portion 14′ as illustrated in FIG. 4. Furthermore, as illustrated in FIGS. 5 and 6, the raised bead portions 14 can have a width extending across a majority of the width of the substrate or less than or equal to half of the width as shown in FIG. 2.

In addition, a pair of parallel raised bead portions 14 can be used side by side, as illustrated in FIGS. 5, 7 and 8. As illustrated in FIGS. 7 and 8, the pair of parallel raised beads 14 can extend from the same side 12a (FIG. 7) or from opposite sides 12a, 12b (FIG. 8) of the substrate 12.

An elastomeric material 30 is over-molded on the metallic substrate 12 and defines first and second sealing beads 32, 34 that each extend beyond respective surfaces of the first and second sides 12a, 12b of the substrate 12. It should be understood that the raised sealing beads 32, 34 can include one or more smaller raised beads portions upon the surfaces thereof. Further, the sealing beads defined by the elastomeric material 30 can take many forms and can be located in various locations, either at an edge of the substrate or overlapping the substrate.

The raised bead portions 14 of the metallic substrate provide for a rigid feature in the gasket that creates a load bearing compression limiting feature so that the over-molded elastomeric sealing beads 32, 34 are not overly compressed. This load bearing compression limiting feature has the function of retaining bolt torque while maintaining a constant gap in a bolted joint to control stresses in the gasketing material to enable long service life of the sealing element. The metallic bead shape can be continuous or intermittent as illustrated in the two embodiments shown to enable the proper surface area and structure to support the bolt tightening load to maintain bolt torque. Additionally, the elastomeric material can be utilized in the concave region 22 of the raised bead to add additional support structure to the metallic bead shape to achieve the proper structure. In addition, the gasket material in conjunction with the metallic bead shape is trapped under the metallic bead shape to create a near hydraulic condition to provide the necessary structure to support the tightening load to maintain the torque while providing a limiting feature to control stresses in the gasket material.

What is claimed is:

1. A gasket, comprising:
a metallic substrate formed of a generally uniform thickness metallic sheet and having a raised bead portion formed therein, said raised bead portion defining a first generally concave surface on a first side of said substrate and a generally convex surface on a second side of said substrate; and
an elastomeric material over-molded on said metallic substrate and defining first and second sealing beads that each extend beyond respective surfaces of said first side and said second side of said substrate.

2. The gasket according to claim 1, wherein said raised bead portion includes a continuous bead extending substantially an entire length of said gasket.

3. The gasket according to claim 1, wherein said raised bead portion includes a plurality of discretely formed raised beads spaced from one another along a length of said gasket.

4. The gasket according to claim 1, wherein said raised bead portion includes a pair of side wall segments and a top wall segment extending between said pair of side wall segments.

5. The gasket according to claim 4, wherein said pair of side wall segments are angled relative to said top wall segment.

6. The gasket according to claim 1, wherein said first sealing bead includes at least one raised bead on a surface thereof.

7. The gasket according to claim 1, wherein said raised bead portion includes a pair of parallel raised beads spaced laterally from one another.

8. The gasket according to claim 7, wherein a first one of said pair of parallel raised beads extend from a first surface of said metallic substrate and a second one of said pair of parallel raised beads extend from a second surface, opposite said first surface of said metallic substrate.

9. The gasket according to claim 7, wherein said pair of parallel raised beads extend from a same surface of said metallic substrate.
